(19) United States
(12) Patent Application Publication
(10) Pub. No.: US 2007/0113993 A1
(43) Pub. Date: May 24, 2007

(54) Method and device for a soft door

(76) Inventors: Adi Goren, Ramat Gan (IL); Uzi Ezra Havosha, Tel Aviv (IL)

Correspondence Address: UZI EZRA HAVESHA & PARTNERS, HADAR-DAFNA HOUSE 39 SHAOUL HAMELECH STREET, TEL AVIV, 64928, IL

(21) Appl. No.: 11/598,439

(22) Filed: Nov. 14, 2006

(30) Foreign Application Priority Data
Nov. 17, 2005 (IL) 172041

(51) Int. Cl. E06B 9/24

(52) U.S. Cl. 160/371

(57) ABSTRACT

A door, optionally with the possibility to assemble as a kit, made essentially from soft and colorful materials and other special features like a magnetized surface and a storage pocket, avoiding sharp edges and being user friendly for children.

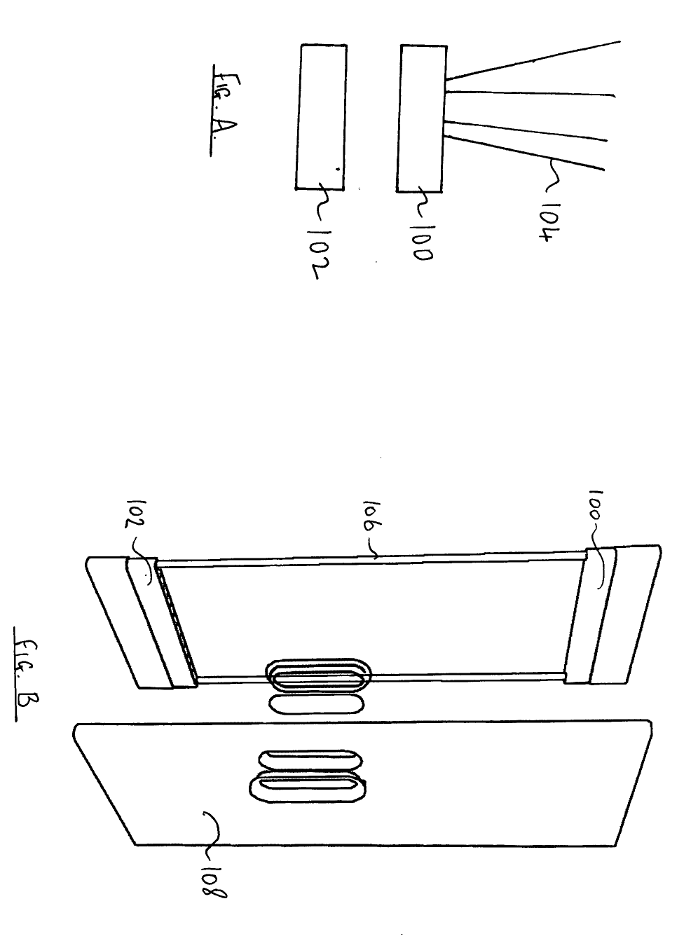

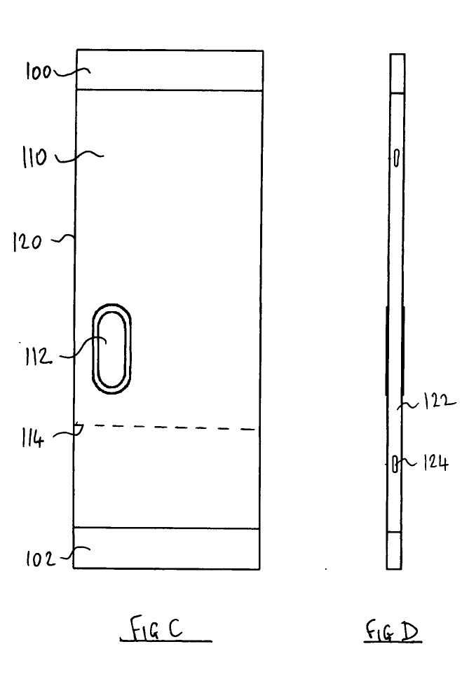

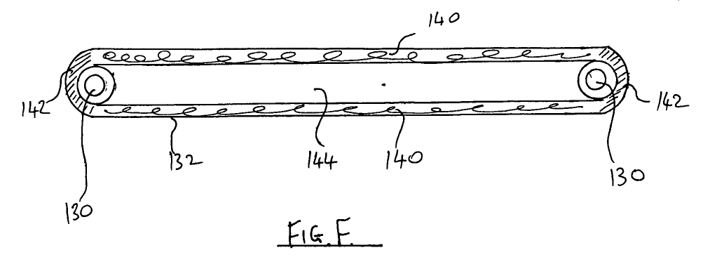

### FIELD of the INVENTION This invention relates to the field of doors and in particular a door made of soft material, suitable for children or other purposes for instance, aesthetics or modern design.

### BACKGROUND OF THE INVENTION

A door is a standard part of most rooms of a house. The styles, colors, material, and design vary slightly but the basic concept is standard. There is usually a rectangular opening in one wall, which is filled by a solid rectangular object, usually made of wood or hard plastic. This door is attached to the wall via a frame and hinges attach the door to the frame. The hinges ensure ease of opening and closing the door, to fit into the said space in the wall.

Some of the problems with the conventional system of doors, especially taking into consideration the special needs of children are:
a) the door is usually hard and can be painful when bumped into,
b) the edges of the door are often sharp,
c) the door handles are usually hard and project from the plane of the door,
d) there is usually a lock which can be used unintentionally, causing a young child anxiety, or used intentionally causing the parents' anxiety,
e) it can slam shut causing great pain if fingers are caught,
f) it can slam shut causing an unpleasant noise,
g) it is usually opaque and thereby creates a solid barrier between those on the inside and those on the outside.
h) it is bulky to transport and maneuver, especially for the end-user who has a private-size car for transportation.

This invention comes to alleviate the above problems by revealing a door made of soft material that is particularly suitable for children but not limited to their use. A modern house design can have a soft look with many objects made with loose form, non-straight lines and soft materials. This invention would fit well into such a design, but could be used with any style or design.

For the purposes of this application for this invention, reference will be made for the most part, as it relates to children's doors but it is understood that this is not a limitation.

### SUMMARY OF THE INVENTION

This invention reveals a new concept in doors especially as it relates to children's doors. It is a door that could be marketed as a complete unit ready for installation or made of parts that can be assembled by the end-user. In this application for this invention, the door described is the type marketed in parts for assembly. The said door can be sold in a convenient sized carrying box that would fit in the boot (trunk) of a private-size car. The base panel and header panel could be made of firmer material like plastic. The width of the door is approximately equal to the width of the base and header panels of door frames. The said panel's width could be fixed or be adjustable in order to fit different sized door-frames. Into the base panel could fit collapsible or telescopic poles, which in turn could hold the material for the body or width of the door. This material can be cloth, leather or anything of like softness and flexibility. It could fit around the framework of said base and header panels and vertical poles. The said poles would need to be made of a firm substance in order to act as a frame to hold the said material but they could have a relatively soft material as their outside layer to protect bodies or parts of bodies from damage or injury by the said door.

The said material could either be a double layer of material or a single one. In the latter case, the material would be attached to one vertical pole and wrap around the other vertical pole as far as necessary to make it taut. At this point, it could be attached to the other part of the material by any convenient means, for example, Velcro™ or a zip. Where the material is a double layer the inside space could be utilized for example, as a pocket for storage. This pocket would be useful for a child to keep toys and other items to attach to the door or for general use. The said material could have attached to its inside (hidden) face an insulating material that would reduce the transfer of noise from outside the room to the inside and visa versa.

Another aspect of this invention is for the double-layered material to have a thin strip of metal or magnetized metal in its hollow section. Alternatively, the material could have metal or magnetized fibers intertwined in or otherwise attached to the material. This aspect would be to enable toys or other items that are magnetized or have a metal portion respectively, to stick to the material face of the door of this invention.

An aspect of this invention could be to sell the door as a kit complete with all its parts including a set of toys or other articles suitable for different age groups. The toys or articles would be made with a metal or magnetized portion for attaching to the magnetized material of the door.

The hinge of this invention could be made to be attached to or be in place of existing hinges. The said hinges could be free swinging or be limited to say 90° or to say 270° or any other angle depending on the needs and desires of the end-user. Such adjustments could be made on the hinge itself and changed when so desired. The said hinges could be the type that hold the door in a closed position but is free to swing open in one or either direction when so pushed and thereafter, with the aid of a spring in the hinge mechanism, return automatically to the closed position.

The door handle of this invention could be a space in the said material with a shaped frame having a sliding solid piece made to close the said space when so desired. Whereas the said solid piece could be normally left open, and then the space could be utilized to be held by the user's hand for the purpose of opening and closing the door, the closing of the said solid piece could indicate a request for privacy. The door of this invention could be with or without a lock and could be with or without conventional door handles.

The door of this invention could be attached to a door frame specially made for the door or could be made with hinges to fit onto the existing door frame.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

FIG. A is a diagram of this invention as and when it is removed from its carrying box.

FIG. B is a diagram of this invention during the assembly process.

FIG. C is a diagram of the door of this invention after assembly.

FIG. D is a diagram of the side view of the door of this invention.

FIG. E is a diagram of the top view of a door pole showing the material wrapped around the pole.

FIG. F is a diagram of the door from the top view.

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

FIG. A shows the door of this invention in its various parts prior to assembly. The horizontal top or header panel 100 and the base panel 102 could be made of a firm material like plastic. The vertical poles 104 could be expanded telescopically or be separate pieces where one end of each piece is a slightly smaller diameter than the other end, so that the poles fit one into the other to form a total of two poles, one at each end of the width of the door. These two poles would be held in place by fitting into the header 100 and base 102 panels. The height of the assembled door would be approximately the height of the poles. The header 100 and base 102 panels could be a fixed size or expandable or contractible in order to fit the space between the door posts.

FIG. B shows the door of this invention partially assembled, namely the head panel 100 and base panel 102 are in place, as is the two assembled poles 106. Optionally, a pliable metal or pliable magnetized sheet is placed between the double layer of material 108 forming the body of the door. This enables metallic toys or other objects to be attached to the body of the door. An alternative to the said metal or magnetized sheet could be for there to be metal pieces or fibers inserted or attached to the material 108.

FIG. C shows the assembled door 120. The material 110 of the door can wrap around the poles and is attached by any convenient method for example a zip or Velcro™. This would enable the door to fit different widths. In this case the header 100 and base 102 panels could be expandable and contractible, to fit the required width. A spring could be used in the said panels to put pressure in a longitudinal direction in order to stretch the material 110. When the door is made with a fixed width the poles could fit into a slot made by the material being folded over into a loop at each end and sown or otherwise attached as shown in FIG. E.

The door-handle 112 is shown as a space in the plane of the door where there is an oval shaped frame that optionally holds a piece that slides up and down. This sliding is slightly stiff so that when the piece in the oval space is lifted it stays in that open position.

The door optionally has a pocket 114. This pocket 114 is open and closed by any convenient method for example with a zip mechanism. The pocket 114 could be used for keeping objects like for example toys, especially those toys that can stick to the door by magnetism. This pocket could have an opening facing to the outside as well as to the inside of the door 120.

FIG. D shows the end view 122 of the door. The hinges 124 could be conventional hinges made to fit existing hinges on the existing doorframe.

FIG. E shows the top view of the pole 130 with the material 132 wrapped around and attached to itself by any convenient and practical method for example, sewing or Velcro™.

FIG. F shows the door from the top view showing the two poles 130 at the two extremes of the width of the door with the material 132 wrapped all the way around the poles making the said material taught. When the door is a fixed width, the material 132 would be one piece of material joined to make an ellipse shape. When the door is made to fit a choice of widths, the material 132 can be wrapped around the poles 130 and one end joined to the other by any means, for example, a zip or Velcro™.

Insulating substance 140 is attached to the inside (hidden) face of the material 132, for the main purpose of reducing sound transfer. Alternatively, the said insulating substance could be one sheet of sponge-like substance placed in the space 144 between the two pieces of material 132.

A soft substance 142 is placed at the outer extremes of the poles 130, the main purpose of which is to protect bodies or parts of bodies from damage or injury as the door opens or closes. The said soft substance 142 could be a sleeve in the shape of a tube that fits over the pole 130 surrounding its circumference and covering its length or part of its length.

What is claimed is:

1. A door comprising
a header panel and a base panel,
two poles fitting into the extremities of the said panels being the height of the said door,
material encompassing the said poles,
whereby there would be a soft door for the benefit of children and/or adults.

2. A door as claimed in claim 1 wherein the said door is made as a complete unit.

3. A door as claimed in claim 1 wherein the said door is made of parts for assembly.

4. A door as claimed in claim 1 wherein the said poles are each a single piece.

5. A door as claimed in claim 1 wherein the said poles are made of constructible parts.

6. A door as claimed in claim 1 wherein the said panels are a fixed length.

7. A door as claimed in claim 1 wherein the said panels are adjustable in length, being the width of the said door.

8. A door as claimed in claim 1 wherein the said material is a fixed width.

9. A door as claimed in claim 1 wherein the said material is adjustable in width.

10. A door as claimed in claim 1 wherein there is an opening in the said material for holding while opening and closing the said door.

11. A door as claimed in claim 10 wherein the said opening can be opened and closed at will.

12. A door as claimed in claim 1 wherein there is an opening in the said material revealing a pocket in between the front and back pieces of material.

13. A door as claimed in claim 12 wherein the said opening can be opened and closed at will.

14. A door as claimed in claim 1 wherein there is a thin and flexible metal film between the layers of material.

15. A door as claimed in claim 14 wherein the said metal film is magnetized.

16. A door as claimed in claim 1 wherein the said material is magnetized with magnetic fibers therein.

17. A door as claimed in claimed 1 wherein the said material has insulating material attached to it.

18. A door as claimed in claimed 1 wherein the said material is an insulating substance.

19. A door as claimed in claimed 1 wherein the hinges that attach the pole adjacent to the door frame, to that door frame is free swinging.

20. A door as claimed in claimed 19 wherein the said hinge can be adjusted to stop the swing of the said door at any angle.

21. A door as claimed in claimed 19 wherein the spring in the said hinge pulls the said door to a closed position.

22. A door as claimed in claimed 1 wherein the said poles have a soft substance between the external extremity of the said pole and the internal face of the said material as the said material wraps around the said pole.

23. A door as claimed in claimed 22 wherein the said soft substance is a tube shape wherein the said pole fits into the said tube shape.

24. A door as claimed in claimed 9 wherein the said material is kept taught by means of a spring in the said panels.
